(19) United States
(12) Patent Application Publication
(10) Pub. No.: US 2012/0254857 A1
(43) Pub. Date: Oct. 4, 2012

(54) SYSTEM AND METHOD FOR INSTALLING AN APPLICATION ON CLIENT MACHINE

(75) Inventors: Yoganand Tumkur Doraiswamy, Mysore (IN); Bhaskara Hegde, Mysore (IN); Anup More, Jaysingpur (IN); Shreshta Shyamsundar, Mysore (IN)

(73) Assignee: INFOSYS TECHNOLOGIES LIMITED, Bangalore (IN)

(21) Appl. No.: 13/182,757

(22) Filed: Jul. 14, 2011

(30) Foreign Application Priority Data
Mar. 31, 2011 (IN) 1054/CHE/2011

(51) Int. Cl. G06F 9/445

(52) U.S. Cl. 717/177

(57) ABSTRACT

The present disclosure relates to a system and a method for installing an application on a client machine. The installation program of the application is stored in a repository and the user requires appropriate permissions to access the repository. The user provides authentication details to the server which in turn provides the user with credentials for installation. Then, the user runs a client application and inputs the credentials thereon to install the application on the client machine. The client application then installs the application available on the repository on the client machine after authenticating the client machine with the server using the credentials.

### TECHNICAL FIELD

The present disclosure relates to field of software management and deployment. In particular, the present disclosure relates to deployment of application in client machine in a secure and systematic manner.

### BACKGROUND

Software delivery and license management has been a challenge in the field of information technology. And most of the solutions present in the market deploy the software by creating a package in the native format. Briefly, software deployment is the process of distributing and configuring application programs to appropriate client locations.

In conventional solutions, software is deployed by installing an active agent on all the client machines in an enterprise and any software that needs to be deployed is packaged and then scheduled for deployment on the client machines.

All the present technologies based on active agent need one high-end server, which either gets the information from the client machine by either push or pull method. Further all the current active agent based solutions require creation of software deployment packages and cannot use the native installation programs that come with the original software. Therefore, dependency on the active agent and package creation is usually a time consuming process and delays the deployment time.

In few conventional solutions, application is installed on the system by information technology staff by visiting the requestor client location or by taking remote on the client machine. In such cases, a lot of manual involvement is required in installing software remotely or in visiting each client's location.

In other conventional systems, an application is installed on the client machine by sharing installation file with user. The user shall then install the software on the client machine using the shared installation file. In case of sharing the installation with the user, administrative rights are required to be provided to the user. The user may copy the installation file and unauthorized distribution or installation of the application is probable. Additionally, several users may require downloading application from the server simultaneously, resulting in peak request overloads which may crash the server.

Therefore, there exists a need to develop a system and a method for deployment of application in a client machine in a secure and systematic manner.

### SUMMARY OF THE DISCLOSURE

In one embodiment, the present disclosure relates to a system for installing an application on a client machine. The system comprises a repository unit, user station, a server, a client machine and a client application. The repository unit is configured to store an installation program of the application. The user station is configured to send a request to the server to install the application on the client machine by providing information of user, client machine and the requested application. Upon receiving the request, the server generates and provides a key to the user station based on the information of user, the client machine and the requested application. Finally, the client application receives the provided key and launches the installation program on the client machine in a power user mode to install the requested application.

In one embodiment, the present disclosure relates to a method for installing an application on a client machine. The installation program of said application is stored in a repository unit. The method comprises sending a request to a server by user station to install the application by providing information of user, client machine and the requested application. Upon receiving the request, generating and providing a key to the user station, by the server, based on the information of user, the client machine and the requested application. Then, a client application is started on the client machine and the provided key is inputted thereon to launch installation program by the client application on the client machine in a power user mode for installing the requested application.

### BRIEF DESCRIPTION OF THE DRAWINGS

The features of the present disclosure are set forth with particularity in the appended claims. The disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates a system for installing an application on client machine in accordance with the present disclosure.

FIG. 2 illustrates a flowchart for installing an application on client machine in accordance with the present disclosure.

FIGS. 3, 4 and 5 illustrate snapshots of the installation process for installing an application on client machine in accordance with the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In one embodiment, the present disclosure relates to a system for installing an application on a client machine. The system comprises a repository unit, user station, a server, a client machine and a client application. The repository unit is configured to store an installation program of the application. The user station is configured to send a request to the server to install the application on the client machine by providing information of user, client machine and the requested application. Upon receiving the request, the server generates and provides a key to the user station based on the information of user, the client machine and the requested application. Finally, the client application receives the provided key and launches the installation program on the client machine in a power user mode to install the requested application.

In another embodiment of the present disclosure, the client machine is permitted to access the repository unit in the power user mode.

In yet another embodiment of the present disclosure, the server generates the key upon determination of availability of the installation program of the requested application in the repository unit.

In still another embodiment of the present disclosure, the client application launches the installation program upon authenticating the provided key with the client machine using the server.

In another embodiment of the present disclosure, the client machine informs the server upon installation of the requested application.

In yet another embodiment of the present disclosure, the server permits the installation of the requested application within a predetermined period of time.

In still another embodiment of the present disclosure, the power user mode permits the client application to install the requested application on the client machine.

In one embodiment, the present disclosure relates to a method for installing an application on a client machine. The installation program of said application is stored in a repository unit. The method comprises sending a request to a server by user station to install the application by providing information of user, client machine and the requested application. Upon receiving the request, generating and providing a key to the user station, by the server, based on the information of user, the client machine and the requested application. Then, a client application is started and the provided key is inputted thereon to launch installation program by the client application on the client machine in a power user mode for installing the requested application.

In another embodiment of the present disclosure, upon installation of the requested application, the client machine informs the server.

In yet another embodiment of the present disclosure, the client application launches the installation program upon authenticating the provided key on the client machine using the server.

In still another embodiment of the present disclosure, generating the key upon determining availability of the installation program of the requested application in the repository unit.

In another embodiment of the present disclosure, the installation of the requested application is permitted within a predetermined period of time.

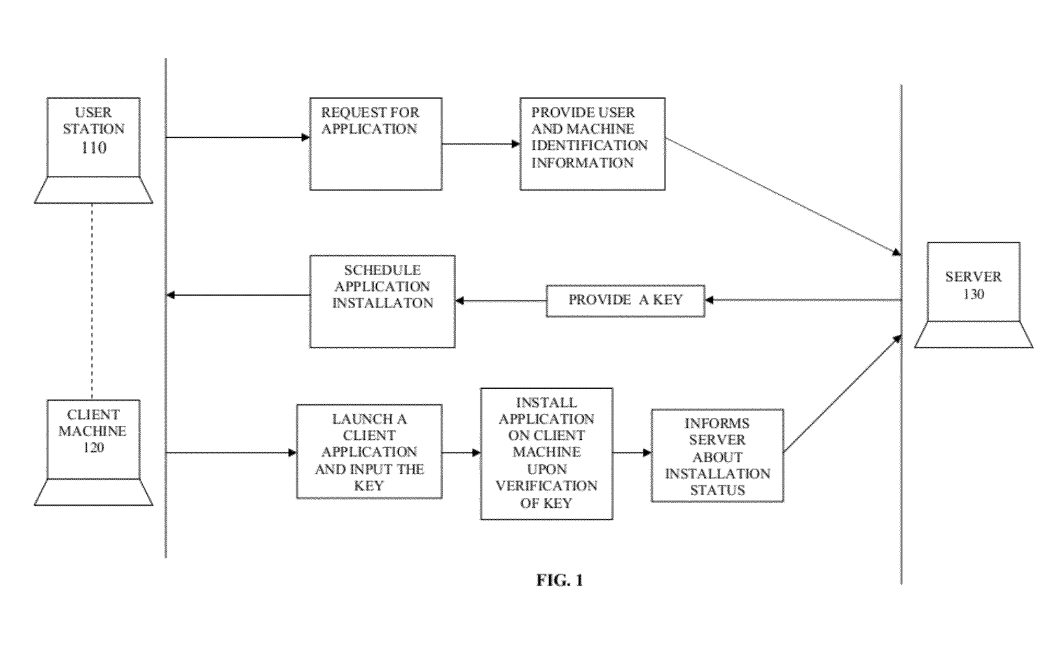

FIG. 1 illustrates a system for installing an application on client machine in accordance with the present disclosure. The system of the present disclosure is based on client server architecture. The client side of the architecture comprises of a plurality of user stations 110. The user station 110 on which the application is to be installed is referred to as client machine 120. Further, the system comprises of a repository (not shown in the figure) which stores the installation program of all the applications. The request for installing an application on the client machine 120 can be generated by user from the client machine 120 or any one of the user stations 110. In one embodiment, the user station 110 generates a request for installing an application on the client machine 120. In addition to the request, the user station provides user and machine identification information and information regarding the requested application. A server 130 receives the request and determines the availability of the installation program of application in the repository. Upon determination of availability, the server provides a key to the user to permit the user to install the application on the client machine 120. The client machine launches a client application and inputs the key therein. In one embodiment, the server provides an installation path to the user to launch the client application. The application is then installed on the client machine 120 upon verification of the inputted key. Upon installation, the client machine 120 informs the status of installation to the server 130.

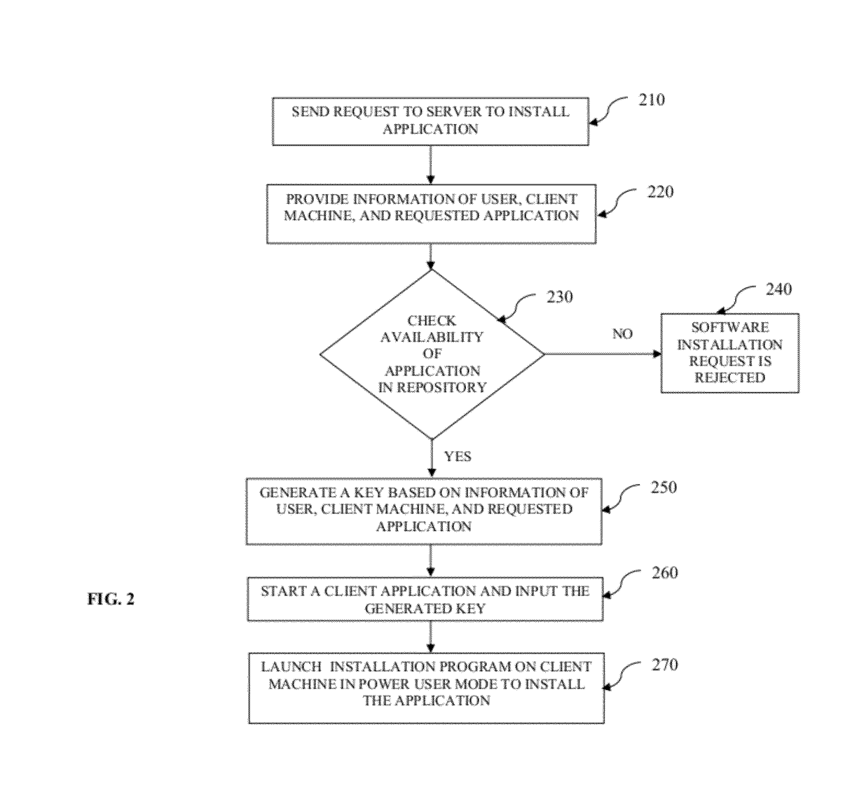

FIG. 2 illustrates a flowchart for installing an application on client machine in accordance with the present disclosure.

In an embodiment, the user raises a request to the server for installation of required application (also referred to as software) at 210. The user can raise the request from the client machine or any of the user stations situated on the client side of the architecture. Along with raising of the request, the user provides user and machine identification information and information of the requested application to the server at 220. Upon receiving the request, the server will check the availability of the installation program of the requested application in the repository at 230. In case the installation program of the requested application is not available in the repository, the request for installation is rejected at 240. If the installation program of the requested application is available and the user is allowed to install the application on the client machine, the server will generate a key based on the user and machine identification information and information of the requested application. The server provides the generated key along with an installation path to access a client application, to the user at 250. The generated key is unique to the client machine for which the user has raised the request. In addition, the server will mention a predetermined period of time within which the application can be installed on the client machine or the time before which the application has to be installed, i.e. setting a time for which the key will be valid for installation. In one embodiment, the period of time can be defined by the user. In another embodiment, the period of time can be defined by the server. The user will then start a client application on the client machine by inputting the provided key into the client application at 260. The user can also start the client applicant using the installation path provided by the server. The server authenticates the provided key with the client machine and launches the installation program of the requested application on the client machine to install the requested application at 270. This ensures that the requested application is installed on the correct client machine and no unauthorized user is allowed to access the application. The installation program is launched on the client machine in a power user mode. The power user mode gives the client machine appropriate permissions to access the installation program stored in the repository for installing the application. The client machine then installs the application and informs the server regarding the status of installation.

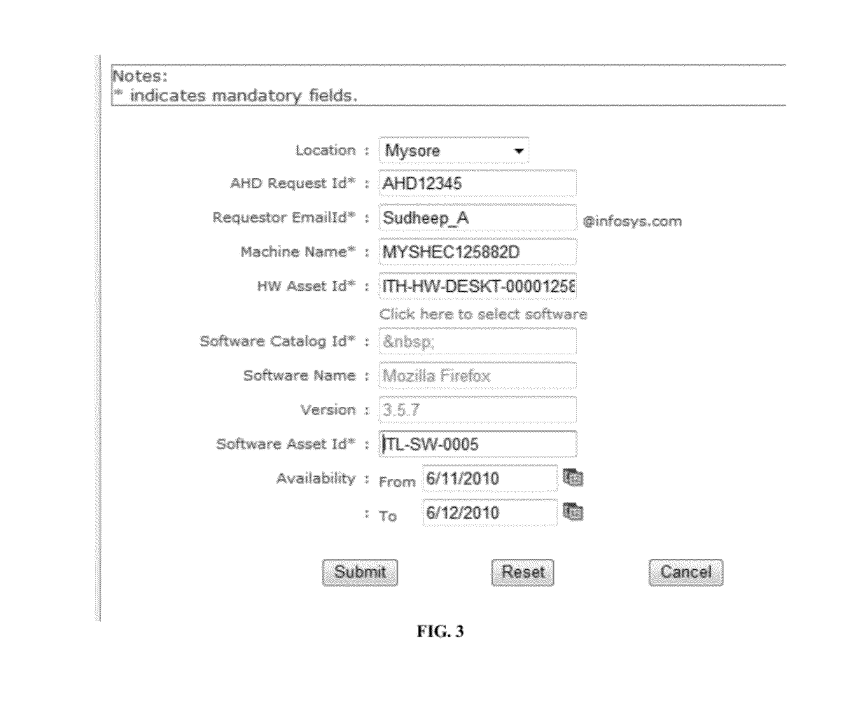

FIGS. 3, 4 and 5 illustrate snapshots of the installation process for installing an application on client machine in accordance with the present disclosure.

FIG. 3 illustrates the process of sending request to the server for installing the application. The snapshot shows information provided by the user to the server for installing an application on the client machine. The user provides location of the client machine, request identification number, e-mail identification of the user of the client machine where the application is to be installed, name of the client machine, hardware asset identification of the client machine. In addition to these user and machine identification information, the client selects the required application to be installed and provides software asset identification. Also, the user can specify the time period within which the user wants to install the application on the client machine. After the expiration of said time period, the application will not be available for installation on the client machine. The user provides all these information and submits the request for application installation.

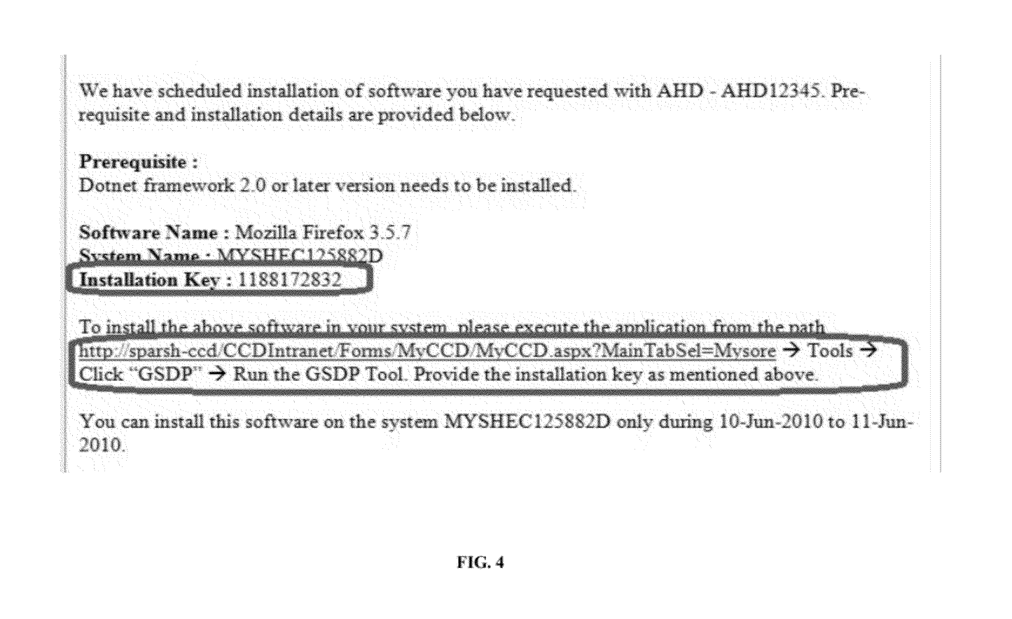

FIG. 4 illustrates the snapshot showing scheduling of application installation by the server. Upon receiving the request for application installation along with the information of client machine, the server determines availability of the application in the repository and generates an installation key unique to the client machine. The installation key is generated based on information of user, client machine and the application required to be installed. The server provides the installation key and optionally an installation path for accessing a client application to the user. The installation path allows the user to launch a client application and install the application stored in the repository. In one exemplary embodiment, the server provides the installation key and the installation path through e-mail.

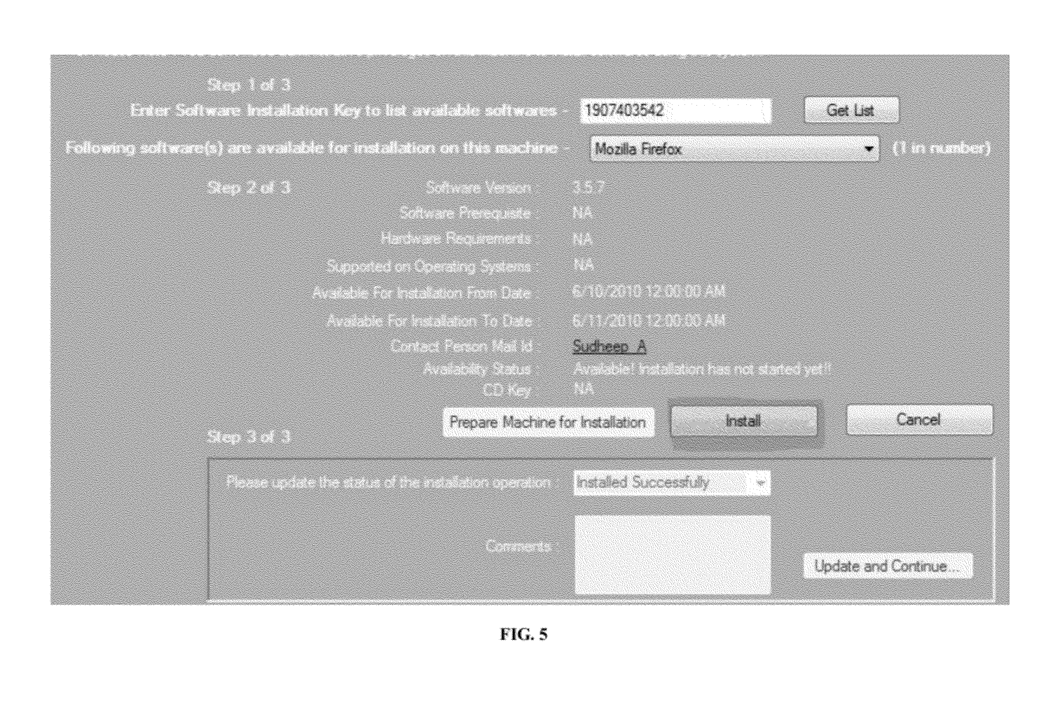

FIG. 5 illustrates the snapshot of the client application launched by the client machine. The client machine launches the client application using the installation path provided by the server and inputs the installation key therein. Upon inputting the installation key, the server authenticates the client machine for installation. Subsequently, the client application installs the application on the client machine. Upon installation, the client machine informs the server about the installation status.

The present disclosure reduces the manual effort and involvement in installing application on end user system. In the present disclosure, the application is installed on the client machine without sharing the installation file with the client. Therefore, any unauthorized installation of application is avoided. Further, the present disclosure enables the user to install the application on the client machine without providing administrative privileges. Further, the present disclosure uses the native installation package that comes with the application and does not require creation of separate package for installation of the application. Also, the time taken for application installation is significantly reduced the present disclosure does not require creation of package.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. A system for installing an application on a client machine, said system comprises:
a repository unit configured to store an installation program of the application;
user station configured to send a request to a server to install the application on the client machine by providing information of user, client machine and the requested application;
the server configured to generate and provide a key to the user station based on the information of user, the client machine and the requested application; and
a client application configured to receive the provided key and launch the installation program on the client machine in a power user mode to install the requested application.

2. The system as claimed in claim 1, wherein the client machine is permitted to access the repository unit in the power user mode.

3. The system as claimed in claim 1, wherein the server generates the key upon determination of availability of the installation program of the requested application in the repository unit.

4. The system as claimed in claim 1, wherein the client application launches the installation program upon authenticating the provided key with the client machine using the server.

5. The system as claimed in claim 1, wherein the client machine informs the server upon installation of the requested application.

6. The system as claimed in claim 1, wherein the server permits the installation of the requested application within a predetermined period of time.

7. The system as claimed in claim 1, wherein the power user mode permits the client application to install the requested application on the client machine.

8. A method for installing an application on a client machine, the installation program of said application being stored in a repository unit, said method comprising acts of:
sending a request to a server by user station to install the application by providing information of user, client machine and the requested application;
generating and providing a key to the user station, by the server, based on the information of user, the client machine and the requested application; and
starting a client application and inputting the provided key to launch installation program by the client application on the client machine in a power user mode for installing the requested application.

9. The method as claimed in claim 8, wherein upon installation of the requested application, the client machine informs the server.

10. The method as claimed in claim 8, wherein the client application launches the installation program upon authenticating the provided key on the client machine using the server.

11. The method as claimed in claim 8, wherein generating the key upon determining availability of the installation program of the requested application in the repository unit.

12. The method as claimed in claim 8, wherein the installation of the requested application is permitted within a predetermined period of time.
